(19) United States
(12) Patent Application Publication
(10) Pub. No.: US 2003/0173465 A1
(43) Pub. Date: Sep. 18, 2003

(54) Spaceshuttle telescope-observatory

(76) Inventor: Zoltan Herpay, London (GB)

Correspondence Address: Dr Zoltan Herpay, 28 Duedley Court, 36 Endell Street, London, WC2H 9RD, GB

(21) Appl. No.: 10/100,732

(22) Filed: Mar. 18, 2002

(51) Int. Cl. B64G 1/22; B64G 1/00

(52) U.S. Cl. 244/158 R

(57) ABSTRACT

A Spaceshuttle telescope-observatory as a singular system has a circularly cross-sectioned long fuselage of a closed tipe and an opening nozzle-cone at the top of a secondary reflector that serves the primary reflector on the top side of the telescope-observatory, while the main reflector and the observatory is located at the bottom part of the fuselage, having the wings, each operative with turbable tips for the collecting of solar radiation. This system have to be launched conventionally by a large lifting body.

This invention relates to a Spaceshuttle telescope-observatory, in which the fuselage of the known Spaceshuttle has a long, circularly cross-sectioned closed body whose nose-cone could be opened, and its wing-tips could be turned for collecting solar radiation.

The Spaceshuttle is known by everybody ever since I submitted my British Patent to the NASA in 1967 of an Aero-Space Flying Observatory, which have had a longitudinally opening fuselage for collecting solar radiation. It became renamed by the NASA into its own Spaceshuttle, for the observatory was removed from it In this specification nothing is similar to that old proposition.

According to the present invention there is provided a new tipe of Spaceshuttle with a rather long cylindrically shaped fuselage, closed on its side, but it could be opened out at its nozzle-cone at the top-end positioned secondary reflector that serves the primary reflector at the top aerea of the observatory, which is at the bottom of the fuselage this time. Instead of opening up the fuselage side-ways, this design suggests the making of the large wing-tips rotatable for collecting solar radiation. The main reflector could be as wide as 6 meters. The observatory offers a a great double walled area for holding propellant fuel. The auxiliary or small movements-initiating mini-rockets are not shown. The system could come back to earth on its own.

A specific embodiment of the invention will now be described by way of example with reference to the accompanying drawing in which:

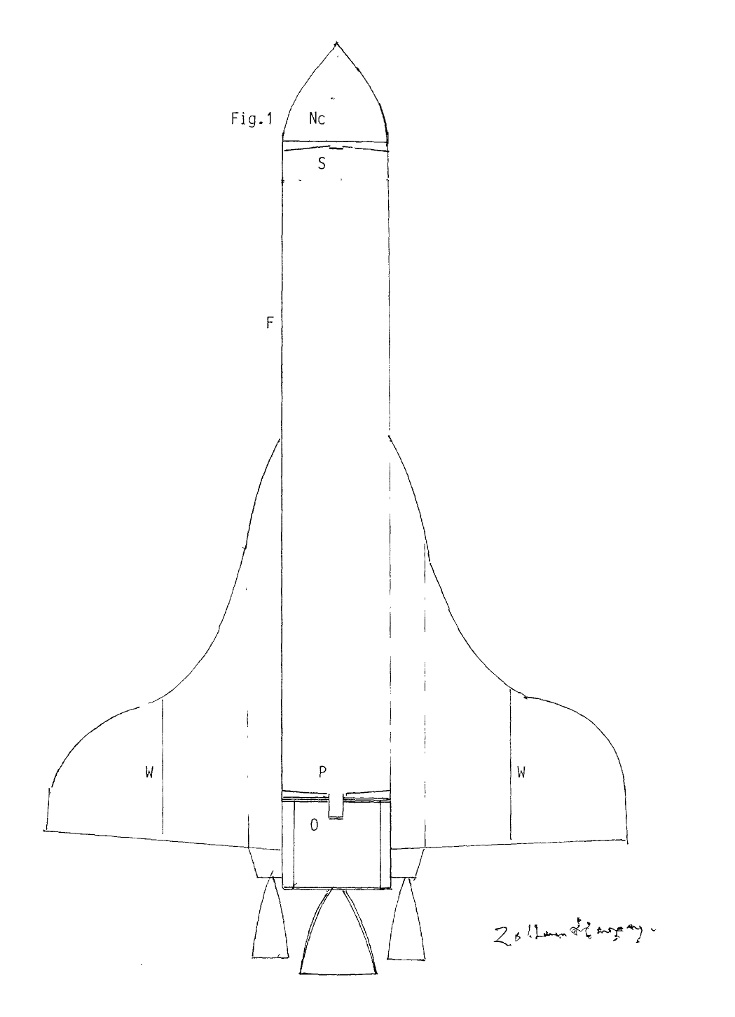

FIG. 1 shows the top planar view in cross-section, as the fuselage is holding the telescope-observatory with a downwardly opening nozzle-cone.

Referring to FIG. 1 the nozzle-cone Nc is closed, but in operation it is opened by a single hinge (not shown) and because it is a rather large object, it could be made operative with as a holder of a snall wide field telescope for helping the main observatory in navigation. The secondary reflector S is fixed. The primary reflector is also fixed also fixed of the observatory P. If it could be 6 meter wide, its body thickness is considerable. Its focal length have to be minimum seven times longer than its width. The double walled observatory 0 is wall protected against gamma-radiation. Being rather large, it could accomodate several observers for a long time. Because the large areas of the wing-tips could be made turnable at a low-cost than the opening of the fuselage, its solar radiation collecting capability is greatly simplified W.

The purpose of all of my Spaceshuttle telescopes and observatories is to advdnce observational astronomy for finding more observational facts, if possible about the detectability of new planets, and about the meaisuring up of the whole observational Universe, before the antisynergetic scientists are going to annihilate nankindm on the huge investments of the tax-payers.

1. A Spaceshuttle Telescope-Observatory, in which the old Spaceshuttle is modified to the requirements of a large telescope-observatory (very much differently from my 1967 design) having a long and stro circularly cross-sectioned closed, tubular fuselage that have to be opened by a single hinge at its nozzle-cone, holding the telescope and the observatory in its whole body, the observatory always at its tail-part.

2. A Spaceshuttle Telescope-Observatory, as claimed in claim 1 in which a part of the Observatory is used for holding propellant fuel materials.

3. A Spaceshuttle Telescope-Observatory, as claimed in claim 1 and 2, in which the wing-tips are turnable towards the sun, while the fuselage and its telescope is controllable by means of auxiliary small rocket engines.

4. A Spaceshuttle Telescope-Observatory, which could fly back to the Earth on its own, in spite of the fact that the main reflector is rather large.
